(19) United States
(12) Patent Application Publication
(10) Pub. No.: US 2026/0016038 A1
(43) Pub. Date: Jan. 15, 2026

(54) BAYONET CONNECTOR

(71) Applicant: ZORYA LLC, Clearfield, UT (US)

(72) Inventors: Tanna Ellis, Pleasant View, UT (US); Courtney E. Woodfield, Clearfield, UT (US); LJ Wilde, Hyrum, UT (US); Zachary S. Ellis, Smithfield, UT (US)

(73) Assignee: ZORYA LLC, Clearfield, UT (US)

(21) Appl. No.: 18/767,626

(22) Filed: Jul. 9, 2024

(51) Int. Cl. F16B 21/04; B25G 3/16

(52) U.S. Cl. CPC F16B 21/04; B25G 3/16

(57) ABSTRACT

A bayonet connector and assembly. The bayonet connector has a threaded protrusion or connector coupled to a bayonet protrusion with a body and a plurality of nubs spaced from the end of the body and spaced radially from each other. There is a screw head and a radial lip that trap an elastic washer. The plurality of nubs are asymmetric and have noses and tails with the noses having shallower tapers than the tails such that the nose presents a more gradual engagement with the traps of the bayonet receiver. The bayonet receiver receives the body and plurality of nubs of the bayonet protrusion axially and on a rotational action to receive and secure the plurality nubs nose-first.

### BACKGROUND OF THE INVENTION

### Field of the Invention

The present invention relates to connectors, specifically to bayonet-style connectors.

### Description of the Related Art

In the related art, it has been known to use hardware connectors to couple structures together. Various types of connectors are used in various settings. Examples include nails, screws, clips, rivets, clamps, and the like. Some variations include male-male connectors that engage with female connecting pieces disposed within the structures to be connected. As examples, there are double shafted nails and screws that can operate similar to dowels but generate a stronger holding grip. There are also bayonet connectors that employ a twist-lock where a male head is inserted into a female receptacle and then the two are twisted in relation to each other to lock in place.

Bayonet connectors are a type of electrical or mechanical fastener commonly used in various industries to secure and connect components. The distinguishing feature of bayonet connectors is the presence of a bayonet lug and corresponding groove, which allows for a quick and secure connection by a simple twist and lock mechanism. The bayonet lug typically has a tapered or helical shape, enabling easy alignment and engagement when the connector is rotated into position. This design provides a reliable and efficient means of joining components, offering advantages such as rapid connection and disconnection, resistance to vibration, and a secure lock that prevents accidental detachment.

Bayonet connectors date at least back to the 19th century when they were initially developed for military applications, particularly in firearms, i.e. a blade adapted to fit the muzzle end of a rifle. Bayonet connectors have since adapted for various purposes, including electrical and electronic applications including but not limited to use in aviation, automotive, military, aerospace, and other industries where quick and secure connections were essential.

One area where connectors are useful is in modular kitchen utensils and similarly, modular cleaning utensils. Modular utensils are tools designed to enhance convenience and efficiency by incorporating a modular or interchangeable head system. The core of these utensils lies in a base handle that allows users to easily swap out different heads, each serving a specific purpose. These interchangeable heads can include spoons, scoops, ladles, spatulas, mops, brooms, containers, and various other kitchen/cleaning essentials. The design facilitates a transition between different cooking tasks without the need for multiple individual utensils, saving both storage space and cleanup time. Further, it allows for separate cleaning of the heads from the handle(s), which can allow for utilization of wooden handles that might not fare well in a dishwasher to be used with plastic and/or metal heads that can be easily washed (e.g. in a dishwasher) separately from the handle.

Some improvements have been made in the field. Examples of references related to the present invention are described below in their own words, and the supporting teachings of each reference are incorporated by reference herein:

U.S. Pat. No. 4,373,828, issued to Sartori, discloses a device for rigidly coupling a handle to its corresponding manual instrument, and an instrument provided with the said device, comprising: a first element that can be connected to a handle, or else be made in one piece therewith, and has a terminal stem, the diameter of which is less, provided with projections whose surfaces, turned towards a shoulder defined by it with respect to the body of the first element, slope both with respect to the axis of the first element and to a plane perpendicular to the said axis; a second element provided internally with an axial hole, which allows the passage of the first element, and a number of projections equal in number or a multiple of those of the said stem, with lower surfaces shaped to accept flush therewith the sloping surfaces of the projections with which the said stem is provided. The coupling is ensured by a ring nut that can be screwed to the first element and be carried flush up against the upper surface of the body of the instrument to which the second element is fastened, and by a locator member positioned at the side of at least one of the projections on the second element.

U.S. Pat. No. 10,182,697, issued to Schultheis et al., discloses a floor cleaning apparatus, comprises a head, the head having a downward facing cleaning element for downward facing cleaning of a ground surface; and a handle for holding; wherein a portion or a whole of the handle is removably attachable from the head and comprises a spraying system, the spraying system itself comprising a spray outlet; the spraying system operable in a first or a second mode, the portion or a whole of the handle attached to the head in the first mode; and the portion or a whole of the handle removed from the head in the second mode, wherein in the first mode spray is sprayable from the spray outlet upwardly with regard to the ground surface. In an alternate aspect, a floor cleaning apparatus, comprises a head, the head having a downward facing cleaning element for downward facing cleaning of a ground surface; and an upward spraying system, the upward spraying system comprising an upward spraying spray outlet.

U.S. Patent Application Publication No.: 20050155186, by McGuyer et a., discloses a handle is ergonomically shaped. It is given a wasp-like shape, with a flexible cover. The handle is used both as a fixed, permanent handle for a single kitchen implement, and as a handle for receiving and holding interchangeable kitchen implements. In one preferred embodiment, the handle has a fluid silicone gel layer underneath an outer-cover to better conform the shape of the handle to the user's hand.

U.S. Patent Application Publication No.: 20230115220, by Harwood et al., discloses a handle system for a woodworking tool to allow both the safe stowage of a woodworking tool and the operational use of the woodworking tool. A handle configured with a first collet receiver and a second collet receiver interconnected at either end of a generally hollow longitudinal handle. The collet receivers are adapted for receiving and interconnecting with a collet, and the collet is configured to receive and hold a woodworking tool therein. The first collet receiver enables the stowage of the woodturning tool within the longitudinal handle, and the second collet receiver enables the use of the woodturning tool in a working configuration which constrains the woodturning tool extending axially away from the longitudinal handle.

The inventions heretofore known suffer from a number of disadvantages which include not being durable, being complicated, being weak, not producing haptic or audible feedback when properly secured, being difficult to engage/disengage, being likely to connect improperly, spontaneously disconnecting during use, being difficult to clean, being prone to get dirty, and failing to produce a solid connection that the user can trust.

What is needed is a connector that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available hardware connectors. Accordingly, the present invention has been developed to provide a bayonet connector and bayonet connector assembly.

According to one embodiment of the invention, there is a bayonet connector, including one or more of: a threaded protrusion that may have a proximal end and/or a terminal end, and/or a bayonet protrusion that may be extending from the proximal end of the threaded protrusion and may include one or more of: a body having a first end, a second end spaced from and opposite thereto, and/or a middle region between the first end and the second end, wherein it may be that the first end is coupled to the proximal end of the threaded protrusion; and/or a plurality of nubs extending laterally from the body, wherein it may be that each of the plurality of nubs protrude radially from the middle region of the body and/or are spaced axially from one or more of the first end and the second end and may be spaced radially from each other.

It may be that there is a screw head that may be disposed between the threaded protrusion and the bayonet protrusion, which may be at the proximal end of the threaded protrusion and which may extend radially therefrom. Further, there may be a radial lip extending radially from the body between the screw head and the plurality of nubs. There may be an elastically deformable washer that may be trapped between the screw head and the radial lip. The threaded protrusion may be a wood screw or a machine screw.

It may be that one of the plurality of nubs has a nose and a tail opposite thereto. The nose may be disposed on a region of the nub that extends orthogonal to the axis of rotation of the body. It may be that the nose has a shallower taper than the tail. It may be that one or more of the plurality of nubs are asymmetrically shaped, left-to-right, such that on rotation of the body about a primary axis thereof in a first direction the nubs present a more gradual engagement and/or on rotation in a second direction opposite to the first direction present a less gradual engagement. It may be that one or more of the plurality of nubs are spaced further from an edge of the second end than a distance that each of the plurality of nubs protrude from the body. It may be that at least one of the plurality of nubs includes a top surface and a bottom surface, wherein the top surface and/or bottom surface extend orthogonally from the body. It may be that the top surface and bottom surface are not parallel to each other.

In another non-limiting embodiment, there is a bayonet connector assembly, which may include one or more of: a connector that may have a proximal end and/or a terminal end, a bayonet protrusion that may extend from the proximal end of the connector and may include one or more of: a body having a first end, a second end spaced from and opposite thereto, and/or a middle region between the first end and the second end, wherein it may be that the first end being coupled to the proximal end of the threaded protrusion, and/or a plurality of nubs extending laterally from the body, each of the plurality of nubs protruding radially from the body and spaced radially from each other, wherein one or more of the plurality of nubs may include a nose disposed at a leading end of the nub; and/or a tail disposed opposite the nose at a trailing end of the nub, wherein it may be that the tail is larger than the nose, and/or a bayonet receiver that may be shaped to receive the body and/or one or more of the plurality of nubs of the bayonet protrusion axially and/or on a rotational action to receive and/or secure the plurality nubs nose-first.

It may be that each of the nubs protrude radially from the middle region of the body and are spaced axially from each of the first end and the second end. It may be that each of the plurality of nubs are spaced axially from the second end by an amount at least equal to a distance that one of the plurality of nubs protrudes from the body. It may be that the bayonet receiver includes one or more of: a cavity having an aperture thereto shaped and sized to receive the body and the plurality of nubs; and/or a plurality of traps disposed within the cavity that are elastically deformable, positioned to each receive one of the plurality of nubs, and shaped to snap-fit the respectively received plurality of nubs on rotational action relative to the bayonet protrusion, wherein the plurality of traps have a smaller entrance than the size of the tail of each the respective plurality of nubs.

There may also be a washer couple between two ridges disposed between the plurality of nubs and a top thread of the connector. It may be that the second end of the body includes a beveled face. There may also be a radial lip extending radially from the body between the screw head and the plurality of nubs, and wherein the plurality of nubs are disposed axially centrally between the radial lip and a terminal edge of the second end of the body such that a midpoint thereof is within some portion of the nub. It may be that the bayonet receiver includes a stair-step shaped aperture shaped to nest the radial lip. It may be that the bayonet receiver includes a trap shaped to receive one of the plurality of nubs, the trap including one or more of: a floor wall, a rear retaining wall coupled to the floor wall and extending therefrom, and/or a ceiling wall protruding from the rear retaining wall at an end thereof opposite to the floor wall, wherein the floor wall and the ceiling wall are shaped to define an inner region that has an entrance opposite to the rear retaining wall, wherein the entrance has a smaller entrance height than a maximum height of the inner region such that it will trap a nub disposed therein. It may be that the plurality of nubs are not spaced orthogonal to each other about a primary axis of the body.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a perspective view of a male-male bayonet connector of a bayonet connector assembly, according to one embodiment of the invention;

FIG. 2 is a side elevational view of a male-male bayonet connector of a bayonet connector assembly in situ, according to one embodiment of the invention;

FIG. 3 is a bottom perspective view of a scoop head having a female bayonet connector of a bayonet connector assembly disposed in a bottom thereof, according to one embodiment of the invention;

FIG. 4 is a cross-sectional side view of a female bayonet connector of a bayonet connector assembly disposed in a bottom of a utensil head, according to one embodiment of the invention;

FIG. 5 is a partial elevational side view of a top portion of a male-male bayonet connector of a bayonet connector assembly, according to one embodiment of the invention;

FIG. 6 is a partial perspective view of a male-male bayonet connector of a bayonet connector assembly, according to one embodiment of the invention; and

FIG. 7 illustrates a plurality of asymmetric protrusion profiles, according to one embodiment of the invention.

### DETAILED DESCRIPTION OF THE INVENTION

For the purpose of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

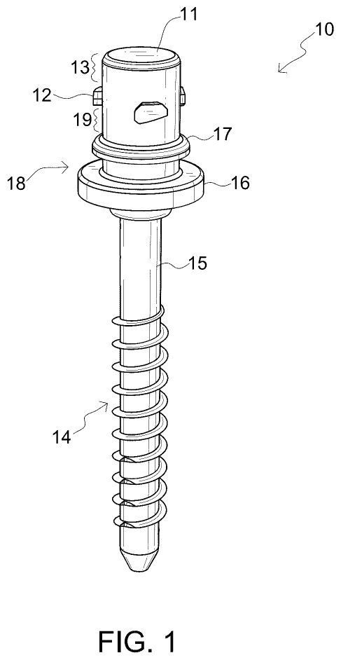

FIG. 1 is a perspective view of a male-male bayonet connector of a bayonet connector assembly, according to one embodiment of the invention. There is shown a male threaded protrusion extending from a male bayonet protrusion having asymmetric nubs extending laterally therefrom and including a screw head disposed between the male threaded protrusion and the male bayonet protrusion. The illustrated bayonet connector provides improved connecting function, especially in heavy-use cases.

The illustrated male threaded protrusion 14 includes a shaft 15 that extends axially away from the cylindrical body of the male bayonet protrusion 10 and includes a proximal end (near the bayonet protrusion) and a terminal end (away from the bayonet protrusion). In another non-limiting embodiment, the shaft may include an elbow that allows the threaded portion to not extend axially from the male bayonet protrusion such that the male bayonet protrusion may couple at an angle thereto. The illustrated male threaded protrusion is of a wood-screw configuration. It is understood that other screw types may be utilized, such as but not limited to machine screws, sheet metal screws, drywall screws, concrete screws, deck screws, self-drilling screws, euro screws, lag screws/bolts, set screws, grub screws, metal roofing screws, and self-tapping screws. The illustrated screw may thread into another object, such as but not limited to a handle, a surface, a tool, or other structure able to receive the threaded protrusion. Advantageously, the threaded protrusion allows for the male-male connector to mount to a structure for later use.

There is a screw head 16 and radial lip 17 spaced 18 therefrom positioned between the male threaded protrusion 14 and the male bayonet protrusion 10 at a proximal end of the male threaded protrusion and at a first end of the body. The illustrated screw head 16 is cylindrical similar to that of a wood screw. It is understood that the screw head could be a hexagonal cylinder or some other shape (e.g. bugle/flat screw head to allow for flush setting of the screw) that extends laterally/radially from the connection between the male threaded protrusion and the male bayonet protrusion. The screw head operates to limit how far the screw may be threaded into a corresponding structure. The screw head also cooperates with the illustrated radial lip 17 as a pair of ridges to make space for and to secure a washer (e.g. an elastically deformable washer like a rubber gasket) therebetween 18. The illustrated radial lip 17 extends from a portion of the cylindrical body at a location spaced from the screw head and the material on each side of the radial lip is the same diameter from the axis of the structure and thus appears to extend from the body of the male bayonet protrusion. However, it is understood that the radius of the region between the radial lip and the screw head need not be the same diameter as the body of the male bayonet protrusion.

The illustrated male bayonet protrusion 10 extends axially from the proximal end of the male threaded protrusion and includes a body with a first end 19, a second end 13 spaced from and opposite thereto, and a middle region between the first end and the second end from which a plurality of nubs 12 extend laterally/radially, the first end 19 being coupled to the proximal end of the threaded protrusion 14. The male bayonet protrusion is shaped to engage with a bayonet receiver and to lock therewith via engagement with the body and the plurality of nubs. The illustrated male bayonet protrusion 10 includes a beveled face 11 disposed at a second end 13 of the body thereof.

The illustrated plurality of nubs 12 extend laterally from the body (three shown, spaced radially from each other at 120 degrees apart each). Each of the illustrated plurality of nubs protrude radially/laterally from the middle region 12 of the body and are spaced axially from each of the first end and the second end and are spaced radially from each other. The illustrated plurality of nubs 12 are each spaced from the beveled face 11 by an amount greater than a distance that each of the plurality of nubs protrude from the body. While the illustrated embodiment shows three nubs, it is understood that there are embodiments that include a different number of nubs other than three. Further, while the illustrated nubs are spaced evenly, it is understood that there are embodiments where the nubs are not spaced evenly (radially) from each other and/or where they are not each spaced the same amount away from the end(s) of the body.

Advantageously, each of the illustrated plurality of nubs are asymmetrically shaped such that when engaged with a matching snap-fit bayonet receiver, the process of twisting the body respective to the receiver to lock the nubs in place is an easier, more gradual process, while the process of disengaging the nubs from the snap-fit receiver takes significantly more effort/force. This asymmetry in the nubs is useful in applications where the connection is likely to experience significant agitation, while still allowing for use of a snap-fit receiver. In the illustrated plurality of nubs, there is shown a nub having a nose (the right side of the nub extending out of the page) and a tail (the left side of the nub extending out of the page) opposite thereto, the nose being disposed on a region of the nub that extends orthogonal to the axis of rotation of the body, and wherein the nose has a shallower taper than the tail (e.g. the tail is fatter top-to-bottom than the nose).

The illustrated nub is asymmetrically shaped, left-to-right, such that on rotation of the body about a primary axis thereof in a first direction the nubs present a more gradual engagement (nose-first) and on rotation in a second direction opposite (tail-first) to the first direction present a less gradual engagement, thereby requiring the snap-fit receiver to open faster and less gradually thus requiring more force per angle of twist in the action to twist the nub out of the receiver. The illustrated nub also includes a top surface (nearer to the beveled face 11 and a bottom surface (nearer to the radial lip 17), wherein the top surface and bottom surface each extend orthogonally from the body. The illustrated top surface and bottom surface are also not parallel to each other, as those surfaces connect the nose and tail of the illustrated nub and since the tail is fatter than the nose, the surfaces that connect the two must be at an angle relative to each other. The illustrated nubs are disposed axially centrally between the radial lip and a terminal edge of the second end of the body such that a midpoint thereof is within some portion of the nub.

In operation, the illustrated male-male bayonet connector is screwed into a structure to a point limited by the screw head. A gasket/washer is secured between the bottom surface of the radial lip and the top surface of the screw head (or top thread of the protrusion, e.g. if there is no screw head). A female bayonet receiver is moved to receive the male bayonet protrusion such that the body and nubs thereof enter the receiver. The receiver and bayonet protrusion are rotated with respect to each other (e.g. one or the other rotate while the other remains still, or they both rotate against each other). As the rotation occurs, the nubs encounter an array of snap-fit traps of the receiver by the nose (nose-first) and the opening of the traps deflect as the nubs engage therewith until the tail passes the opening upon which the traps snap closed about the tail thus entrapping the nubs in place. When it is desired to disengage, the protrusion and receiver are rotated in an opposite direction and the tails of the nubs press against the openings of the traps causing deflection, but at a faster rate of deflection because of the asymmetric shape of the nubs, thus causing significantly increased resistance to opening. As the rotation continues the nubs exit the opening of the traps and then the protrusion may be slid out of the receiver.

While the specific implementations of this male-male bayonet connector are plethoric, the inventor has experimented with utilizing this technology for modular kitchen utensils and has found that the connector provides enhanced utility over other connector types. In particular, the illustrated connector may be implemented to create a set of kitchen tools that can have a plurality of different heads, each coupling to the same handle. Advantageously, a user can take the heads off and wash the heads in the dishwasher while leaving a beautiful wood handle away from the heat and the chemicals involved in the washing process. The heads remain securely attached during use, which involves significant agitation, especially for whisks and other stirring tools.

According to one embodiment of the invention, there is a stainless steel (e.g. to withstand dishwasher and be food safe) male-male bayonet connector and associated receiver. It may be that tolerances for the connector mechanism are tight so that it functions well in both the connection and the disconnection. The connector is a wood screw on one end and then the other end has a special bayonet coupling post that functionally couples to a matching/mating bayonet receiver on each of the head attachments. The nubs on the bayonet connector are recessed from the end of the post and are angled in shape instead of rounded so that they snap into place easier on attaching and have a guiding action that results in a firm connection because they are harder to disconnect.

According to another non-limiting embodiment, there is a male-male connector including a screw and bayonet post with recessed nubs having angled sides and a flange to hold a gasket that applies pressure to help lock in the connector when attached. It may be that the recessed nubs are asymmetrically shaped to make it easier to attach then to detach and to guide the protrusion through the lateral snap-fit path and wedge open the gate/opening when going in/out.

According to yet another non-limiting embodiment, the male-male connector is lacking one or more of the screw head, radial lip, and/or washer/gasket, and/or the face of the body is not beveled but is instead flat, curved, or otherwise textured in a manner different from being beveled.

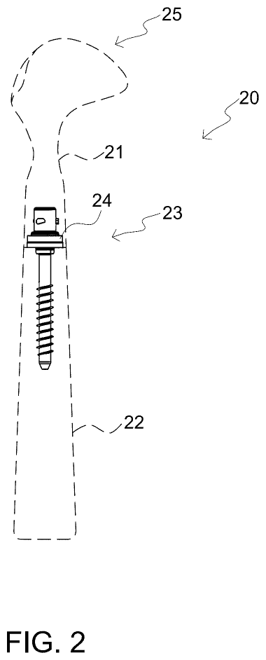

FIG. 2 is a side elevational view of a male-male bayonet connector of a bayonet connector assembly in situ as a tool 20, according to one embodiment of the invention. There is shown a handle 22 into which the male-male bayonet connector 23 is screwed and a head 25 having a neck 21 into which the male-male bayonet connector is coupled via the bayonet protrusion. The illustrated male-male connector 23 includes a washer/gasket 24 disposed between a radial lip and screw head. The illustrated head 25 is of a scoop (e.g. ice cream scoop). Advantageously, the scoop head may be utilized to scoop food and then when finished, the head may be detached from the handle and washed separately. The illustrated washer/gasket provides a bias force that restricts wiggling of the connection between the head and handle, thereby improving operation of the tool 20.

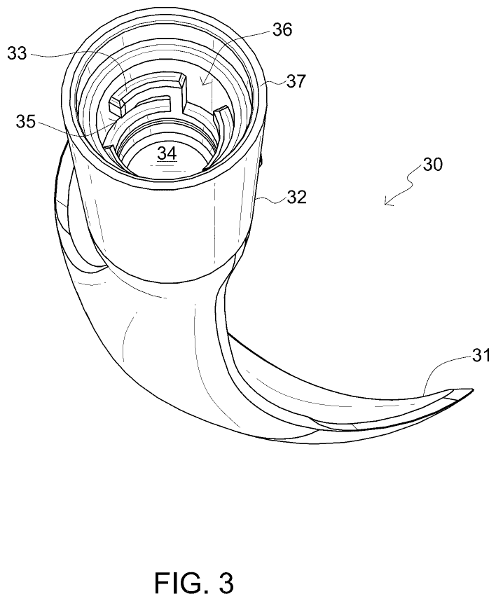

FIG. 3 is a bottom perspective view of a scoop head having a female bayonet connector of a bayonet connector assembly disposed in a bottom thereof, according to one embodiment of the invention. There is shown a head 30 having a scoop body 31 extending from a scoop neck 32 having a bottom aperture 37 of a cavity providing access to a female bayonet receiver disposed therein.

The illustrated female bayonet receiver cavity is shaped and sized to receive the body and plurality of nubs of a bayonet protrusion axially via the bottom aperture (opening) 37 and via the illustrated axial gap 36. There are a plurality of traps disposed within the cavity that match in number with the plurality of nubs of the associated bayonet protrusion. The illustrated traps are elastically deformable at the illustrated deflection arm 33.

On a rotational action of the receiver with respect to the bayonet protrusion, the receiver receives and secures a plurality nubs of the bayonet protrusion nose-first through the illustrated radial gap 35 via elastic deflection of a portion of the bayonet receiver (in the illustrated case via deflection of the deflection arm 33) to snap-fit the plurality of nubs. Further, the illustrated floor 34 of the receiver is beveled and engages with the body of the bayonet protrusion (i.e. a beveled face) to reduce/prevent wiggling of the connection. The beveling of the floor helps to guide the beveled face into an identical engagement each coupling. The illustrated floor 34 is spaced from the trap an amount that matches with how much the nubs are spaced from the beveled face of the bayonet protrusion such that the beveled face nests into and engages firmly with the floor.

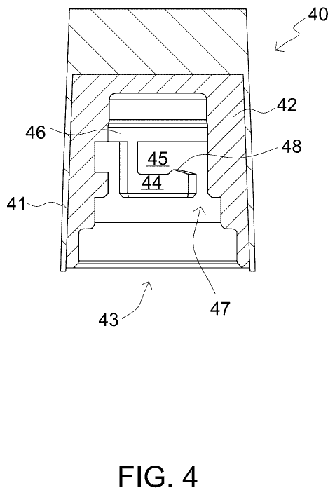

FIG. 4 is a cross-sectional side view of a female bayonet connector of a bayonet connector assembly disposed in a bottom of a utensil head, according to one embodiment of the invention. There is shown a structure 40 with a cup-shaped void 41 enclosing a receiver 42 (generally via an adhesive/cemented/welding connection or other permanent coupling) having a cavity 43 with a stair-step shaped aperture shaped to nest a radial lip into which a bayonet protrusion may be inserted for coupling thereto.

The illustrated receiver 42 includes an axial gap 47 through which a nub may enter, axially, to be presented with the elastically deformable trap 45 formed by the illustrated floor wall 46, and deflection arm 44 (formed as a rear retaining wall coupled to the floor wall 46 and extending therefrom and a ceiling wall orthogonal to and extending from the rear retaining wall and opposite to the floor wall). The illustrated deflection arm 44 includes a diverging member 48 that intrudes into the radial gap of the trap 45 such that the entrance to the trap is smaller than the trap itself and smaller than the tail size of the associated nubs. Wherein the entrance has a smaller entrance height than a maximum height of the inner region and such height is also smaller than a maximum height of an associated nub, the trap will trap a nub disposed therein

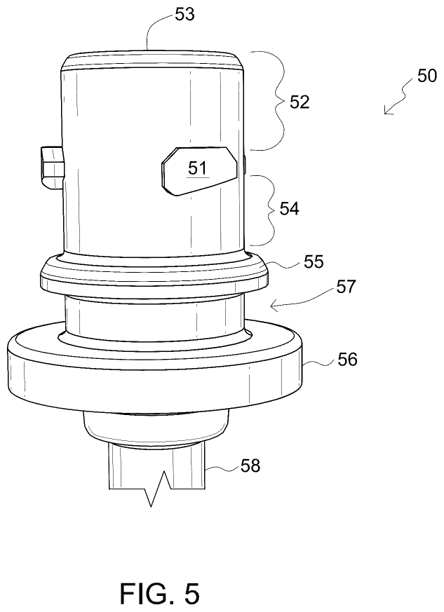

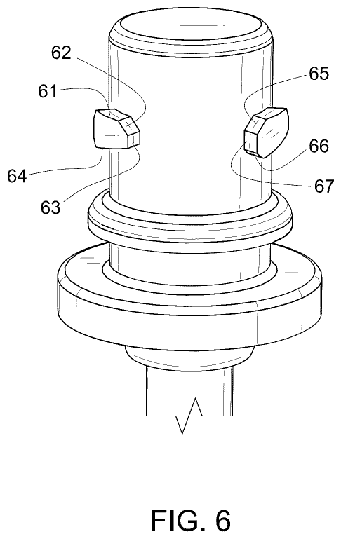

FIGS. 5 and 6 are partial elevational side views of a top portion of a male-male bayonet connector of a bayonet connector assembly, according to one embodiment of the invention. There is shown a plurality of nubs that are not spaced orthogonal to each other about a primary axis of the body, but instead are spaced radially at approximately 120 degrees from each other (i.e. at thirds radially). The illustrated nubs 51 are disposed on the body 50 of the top portion of a male-male bayonet connector having a shaft 58 coupled to a screw head (first ridge) 56 spaced from a radial ridge (second ridge) 55 thereby forming a washer retainer 57 wherein a washer/gasket may be disposed.

The illustrated nubs are spaced (52 and 54) from the radial ridge 55 and the illustrated beveled face 53 such that the nubs are disposed at or near a midpoint therebetween. The illustrated nubs protrude from the body 50 an amount that is less than the spacing 52 from the beveled face 53. Each nub includes a top 61 and bottom 64 surface and those surfaces, while each being orthogonal to the body 50 are not parallel to each other.

The illustrated nubs are asymmetrically shaped such that there is a narrow nose and a fat tail. The illustrated nubs are shaped by flat segments (faces) 61, 62, 63, 64, 65, 66, and 67 that connect to each other and form the perimeter of the nub. The nose of each nub is formed by faces 61, 62, and part of 64, while the tail of each nub is formed by 65, 66, and 67. Notably, the height of the nose (i.e. the height of 63) is smaller than the height of the tail (i.e. the height of 67) and the gradual shift in height along 61, 62, and 64 is a shallower angle and more gradual height change than that of 65 and 66. Accordingly, when the nose encounters a radial gap of a receiver, it takes less force over a longer distance to enter the trap, and oppositely, when the tail encounters a radial gap of a receiver, going the opposite direction to exit the trap, it takes more force over a shorter distance to exit the trap. This asymmetry changes the feel and operation of the connector in a manner that enhances the security of the connection, reduces wiggle/wobble while connected and makes it easier to initially connect the device properly.

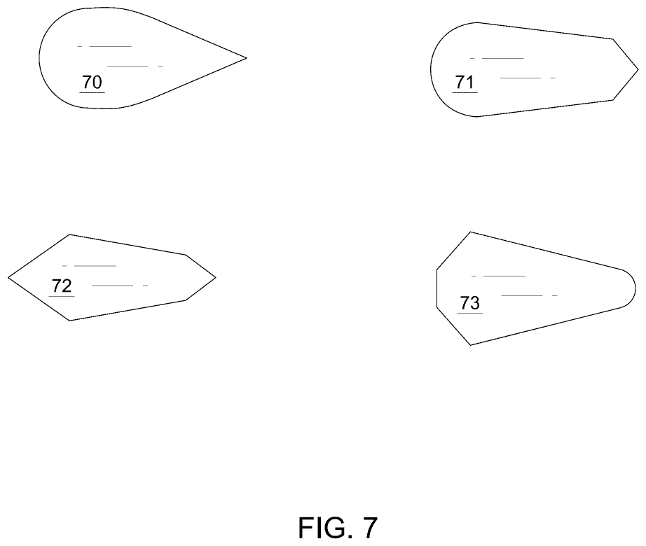

FIG. 7 illustrates a plurality of asymmetric protrusion profiles, according to one embodiment of the invention. There is shown a non-limiting selection of four nub shapes 70, 71, 72, and 73 that are each asymmetric (left to right), have noses smaller than tails, and have more gradual progression/slope from nose to tail than from tail to nose.

The first nub shape 70 is generally teardrop shaped and includes a sharp nose and rounded tail. The sharp nose includes linear segments that curve into the tail region which is semi-circular.

The second nub shape 71 is similar to the teardrop of 70, but instead has a sharp transition from the linear segments of the nose to the curved segment of the tail.

The third nub shape 72 is similar to the nose of 71 but instead of being teardrop shaped in the tail mirrors the nose in line segments but opens up at a larger angle to quickly reach the fat tail height. This is similar to the nub shape of FIGS. 5 and 6 but is symmetric top to bottom while being asymmetric left to right.

The fourth nub shape 73 has a linear snub tail as in FIGS. 5 and 6, is top/bottom symmetrical as in the third shape 72 but has a rounded nose that is not as fat as the tail.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A male-male bayonet connector, comprising:
a. a male threaded protrusion having a proximal end and a terminal end; and
b. a male bayonet protrusion extending from the proximal end of the threaded protrusion and including:
i. a body having a first end, a second end spaced from and opposite thereto, and a middle region between the first end and the second end, the first end being coupled to the proximal end of the threaded protrusion; and
ii. a plurality of nubs extending laterally from the body, each of the plurality of nubs protruding radially from the middle region of the body and spaced axially from each of the first end and the second end and spaced radially from each other.

2. The bayonet connector of claim 1, further comprising a screw head disposed between the threaded protrusion and the bayonet protrusion at the proximal end of the threaded protrusion and extending radially therefrom.

3. The bayonet connector assembly of claim 2, further comprising a radial lip spaced from the screw head and extending radially between the screw head and the plurality of nubs.

4. The bayonet connector of claim 3, further comprising an elastically deformable washer trapped between the screw head and the radial lip.

5. The bayonet connector of claim 1, wherein the threaded protrusion is a wood screw or a machine screw.

6. The bayonet connector of claim 1, wherein one of the plurality of nubs has a nose and a tail opposite thereto, the nose being disposed on a region of the nub that extends orthogonal to the axis of rotation of the body, and wherein the nose has a shallower taper than the tail.

7. The bayonet connector of claim 1, wherein each of the plurality of nubs are asymmetrically shaped, left-to-right, such that on rotation of the body about a primary axis thereof in a first direction the nubs present a more gradual engagement and on rotation in a second direction opposite to the first direction present a less gradual engagement.

8. The bayonet connector of claim 1, wherein the plurality of nubs are each spaced further from an edge of the second end than a distance that each of the plurality of nubs protrude from the body.

9. The bayonet connector of claim 1, wherein at least one of the plurality of nubs includes a top surface and a bottom surface, wherein the top surface and bottom surface each extend orthogonally from the body but are not parallel to each other.

10. A bayonet connector assembly, comprising:
a. a connector having a proximal end and a terminal end;
b. a bayonet protrusion extending from the proximal end of the connector and including:
i. a body having a first end, a second end spaced from and opposite thereto, and a middle region between the first end and the second end, the first end being coupled to the proximal end of the threaded protrusion; and
ii. a plurality of nubs extending laterally from the body, each of the plurality of nubs protruding radially from the body and spaced radially from each other, the plurality of nubs each including:
1. a nose disposed at a leading end of the nub; and
2. a tail disposed opposite the nose at a trailing end of the nub, wherein the tail is larger than the nose; and
c. a bayonet receiver shaped to receive the body and plurality of nubs of the bayonet protrusion axially and on a rotational action to receive and secure the plurality nubs nose-first via elastic deflection of a portion of the bayonet receiver to snap-fit the plurality of nubs.

11. The bayonet connector assembly of claim 10, wherein each of the nubs protrude radially from the middle region of the body and are spaced axially from each of the first end and the second end.

12. The bayonet connector assembly of claim 11, wherein each of the plurality of nubs are spaced axially from the second end by an amount at least equal to a distance that one of the plurality of nubs protrudes from the body.

13. The bayonet connector assembly of claim 10, wherein the bayonet receiver includes:
a. a cavity having an aperture thereto shaped and sized to receive the body and the plurality of nubs; and
b. a plurality of traps disposed within the cavity that are elastically deformable, positioned to each receive one of the plurality of nubs, and shaped to snap-fit the respectively received plurality of nubs on rotational action relative to the bayonet protrusion, wherein the plurality of traps have a smaller entrance than the size of the tail of each the respective plurality of nubs.

14. The bayonet connector assembly of claim 10, further comprising a washer couple between two ridges disposed between the plurality of nubs and a top thread of the connector.

15. The bayonet connector assembly of claim 10, wherein the second end of the body includes a beveled face.

16. The bayonet connector assembly of claim 10, further comprising a radial lip extending radially from the body between the screw head and the plurality of nubs, and wherein the plurality of nubs are disposed axially centrally between the radial lip and a terminal edge of the second end of the body such that a midpoint thereof is within some portion of the nub.

17. The bayonet connector assembly of claim 16, wherein the bayonet receiver includes a stair-step shaped aperture shaped to nest the radial lip.

18. The bayonet connector assembly of claim 10, wherein the bayonet receiver includes a trap shaped to receive one of the plurality of nubs, the trap including:
a. a floor wall;
b. a rear retaining wall coupled to the floor wall and extending therefrom; and
c. a ceiling wall protruding from the rear retaining wall at an end thereof opposite to the floor wall, wherein the floor wall and the ceiling wall are shaped to define an inner region that has an entrance opposite to the rear retaining wall, wherein the entrance has a smaller entrance height than a maximum height of the inner region such that it will trap a nub disposed therein.

19. The bayonet connector assembly of claim 10, wherein the plurality of nubs are not spaced orthogonal to each other about a primary axis of the body.

20. A bayonet connector assembly, comprising:
a. a threaded protrusion having a proximal end and a terminal end;
b. a bayonet protrusion extending from the proximal end of the threaded protrusion and including:
i. a body having a first end, a second end spaced from and opposite thereto, and a middle region between the first end and the second end, the first end being coupled to the proximal end of the threaded protrusion; and
ii. a plurality of nubs extending laterally from the body, each of the plurality of nubs protruding radially from the body and spaced radially from each other, the plurality of nubs each including:
1. a nose disposed at a leading end of the nub; and
2. a tail disposed opposite the nose at a trailing end of the nub, wherein the tail is larger than the nose;
c. a bayonet receiver shaped to receive the body and plurality of nubs of the bayonet protrusion axially and on a rotational action to receive and secure the plurality nubs nose-first, wherein the bayonet receiver includes:
i. a cavity having an aperture thereto shaped and sized to receive the body and the plurality of nubs; and
ii. a plurality of traps disposed within the cavity that are elastically deformable, positioned to each receive one of the plurality of nubs, and shaped to snap-fit the respectively received plurality of nubs on rotational action relative to the bayonet protrusion, wherein the plurality of traps have a smaller entrance than the size of the tail of each the respective plurality of nubs;
d. a screw head disposed between the threaded protrusion and the bayonet protrusion at the proximal end of the threaded protrusion and extending radially therefrom; and
e. a radial lip extending radially from the body between the screw head and the plurality of nubs.
